(19) United States
(12) Patent Application Publication
(10) Pub. No.: US 2018/0248390 A1
(43) Pub. Date: Aug. 30, 2018

(54) SYSTEM AND METHOD FOR MANAGING POWER

(71) Applicant: Jeremiah Couloute, Glastonbury, CT (US)

(72) Inventor: Jeremiah Couloute, Glastonbury, CT (US)

(21) Appl. No.: 15/905,505

(22) Filed: Feb. 26, 2018

Related U.S. Application Data
(60) Provisional application No. 62/463,070, filed on Feb. 24, 2017.

(51) Int. Cl. H02J 7/00; H02M 3/335; H01M 10/0525

(52) U.S. Cl. CPC H02J 7/0021; H02J 7/0052; H01M 10/0525; H02M 3/33507; H02J 7/0068

(57) ABSTRACT

An autonomous self-charging system generating power capable of being connected to external electrical devices is disclosed. A rechargeable power storage device capable of storing power and providing electrical power is electrically connected to an inverter. The external electrical devices are connectable to the inverter. A controller is configured to manage and control electrical power to the inverter and the rechargeable power storage device. The controller monitors an amount of power in the rechargeable power storage device and monitors the power required at the inverter. The controller is configured to maintain a predetermined amount of power in the rechargeable power device and provide the power required to the inverter.

### CROSS-REFERENCE TO RELATED APPLICATIONS

This application claims priority to and the benefit of U.S. Provisional Application No. 62/463,070, entitled “A Generator Electrical System and Method,” filed on Feb. 24, 2017, which is hereby incorporated by reference in its entirety.

### BACKGROUND OF DISCLOSURE

Consumers demand for electrically powered devices has been increasing. Electrical power can be provided by batteries or electrical generators. Electrical power in residential and most commercial businesses is subject to the limitations of the electrical grid. Only a very small portion of electrical power today is provided by renewable resources, such as solar or wind. Electrical power generation can therefore be costly and inefficient. Nearly all electrical power is provided to consumers with an aging electrical grid that is susceptible to interruption during storms and natural disasters. Accordingly, consumers continually desire alternative sources of power that can overcome one or more of the limitations of traditional power.

Renewable energy sources are increasing in popularity but typically have limitations, such as providing intermittent power. For example, solar power and wind power have inherent limitations of requiring wind energy or solar energy to provide power. Constant power can be difficult, especially in instances of intermittent power creation and peaks of power consumption.

Therefore, there is a need for power systems and power management systems that can overcome one or more of these limitations.

### SUMMARY OF THE DISCLOSURE

This summary is provided to introduce a selection of concepts that are further described below in the detailed description. This summary is not intended to identify indispensable features of the claimed subject matter, nor is it intended for use as an aid in limiting the scope of the claimed subject matter.

In one or more embodiments, a system is disclosed having a rechargeable power storage device capable of storing power and providing electrical power. An inverter can be electrically connected to the rechargeable power storage device and connectable to an external device. The inverter is configured to provide power to the external device. A controller is configured to manage and control electrical power to the inverter and the rechargeable power storage device. The controller monitors an amount of power in the rechargeable power storage device and monitors the power required at the inverter, and the controller is configured to maintain a predetermined amount of power in the rechargeable power device and provide the power required to the inverter.

In one or more embodiments, a system can have a fan rotatable to provide wind energy into the system is disclosed. The system can have a turbine and generator capable of converting the wind energy into electrical energy. A rechargeable battery may provide electrical power to the fan. A regulator can be electrically connected between the fan and the rechargeable battery to adjust an amount of power provided to the fan. An inverter can be electrically connected to the rechargeable battery and the generator to provide electrical power to devices external to the system. A controller is electrically connected to control the power to and from the rechargeable battery, to the regulator, and to the inverter, and the controller is configured to maintain a predetermined charge in the rechargeable battery and provide the power required by the inverter.

In one or more embodiments, a method is disclosed that provides a single, self-contained housing having a battery and an electrical connection for powering an electrical, external device. The method can include the step of drawing air or wind into the housing with a plurality of fans positioned within the housing. Further, the method can include the step of converting the air or wind energy into electrical energy within the housing. The method can provide electrical power to the electrical connection and the battery. Additionally, the method can control the power to maintain a predetermine amount of energy in the battery and for providing the power required at the electrical connection by the external device.

These and additional aspects of the present disclosure are set forth in the description that follows, and/or may be learned by a person having ordinary skill in the art by reading the material herein and/or practicing the principles described herein. At least some aspects of the present disclosure may be achieved via means recited in the attached claims.

### BRIEF DESCRIPTION OF THE DRAWINGS

The present disclosure is understood from the following detailed description when read with the accompanying figures. It is emphasized that, in accordance with the standard practice in the industry, various features are not drawn to scale. In fact, the dimensions of the various features may be arbitrarily increased or reduced for clarity of discussion.

FIG. 1A is an external, perspective view of a housing of a system according to one or more aspects of the present disclosure.

FIG. 1B is an external, perspective view of a housing of a system according to one or more aspects of the present disclosure.

FIG. 1C is a view of at least a portion of a system illustrating fans, a turbine, gears, a generator and a power storage device according to one or more aspects of the present disclosure.

FIG. 1D is a view of at least a portion of a system illustrating a generator, turbine, gears and a power storage device for generating and storing power according to one or more aspects of the present disclosure.

FIG. 2A is a view of at least a portion of a system showing a turbine and a power storage device according to one or more aspects of the present disclosure.

FIG. 2B is a view of at least a portion of a system illustrating a turbine and fans according to one or more aspects of the present disclosure.

FIG. 3 is a schematic of at least a portion of a system showing electrical connections between components of the system according to one or more aspects of the present disclosure.

### DETAILED DESCRIPTION OF THE DISCLOSURE

It is to be understood that the following disclosure provides many different embodiments, or examples, for implementing different features of various embodiments. Specific examples of components and arrangements are described below to simplify the present disclosure. These are, of course, merely examples and are not intended to be limiting. In addition, the present disclosure may repeat reference numerals and/or letters in the various examples. This repetition is for simplicity and clarity, and does not in itself dictate a relationship between the various embodiments and/or configurations discussed.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the present systems and methods and their practical applications, to thereby enable others skilled in the art to best utilize the present systems and methods and various embodiments with various modifications as may be suited to the particular use contemplated.

Unless otherwise noted, the terms “a” or “an,” as used in the specification and claims, are to be construed as meaning “at least one of.” In addition, for ease of use, the words “including” and “having,” as used in the specification and claims, are interchangeable with and have the same meaning as the word “comprising.” In addition, the term “based on” as used in the specification and the claims is to be construed as meaning “based at least upon.”

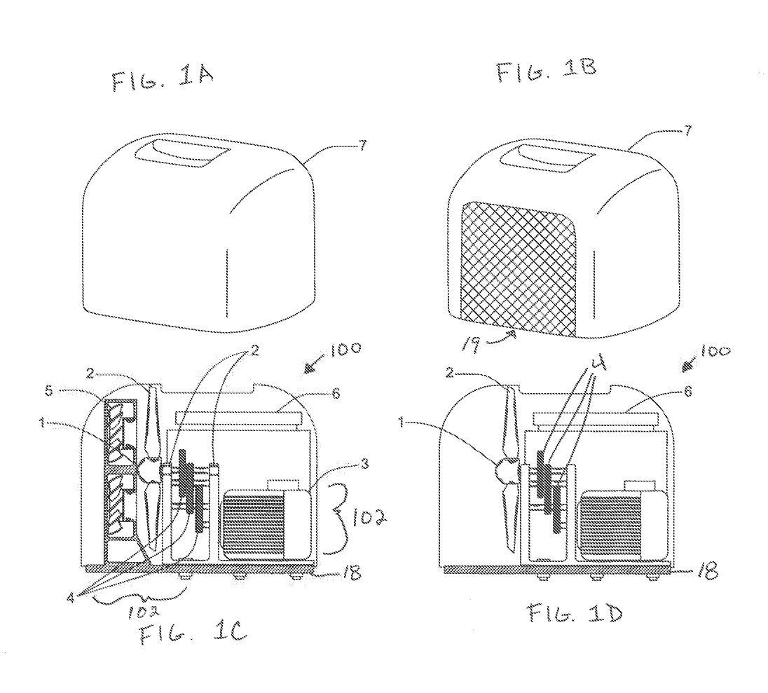

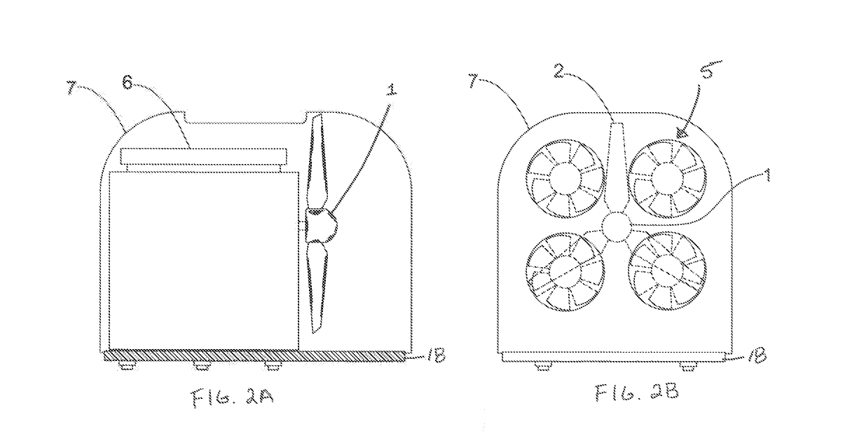

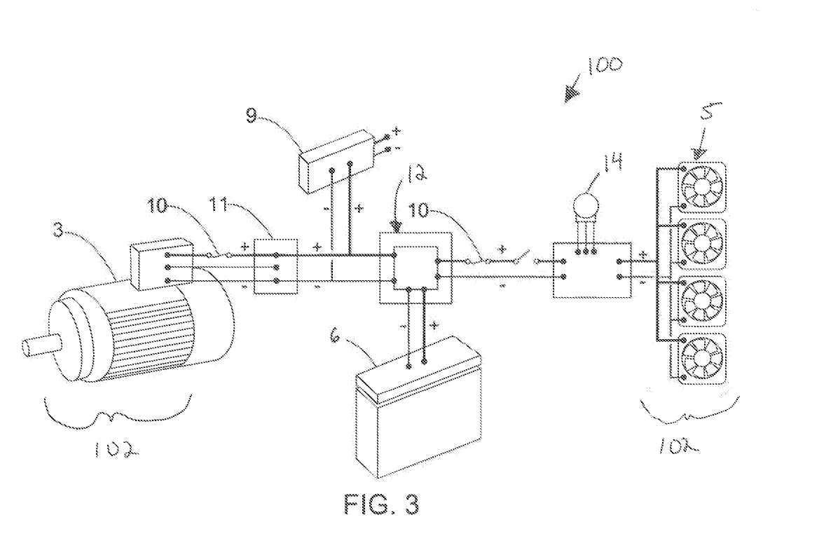

Turning to FIGS. 1C and 1D and FIG. 3, examples of embodiments of the system 100 are shown. A person having ordinary skill in the art will appreciate that various configurations, additional components may be provided or eliminated, and other modifications may be provided within the spirit of the disclosed invention. Neither FIG. 1 nor the other figures or drawings are used herein to limit the invention, and the claims provided herein set forth the meets and bounds of the claimed invention.

As shown in FIGS. 1C and 1D and FIG. 3, a power storage device 6 is generally shown. The power storage device 6 can be rechargeable, such as a rechargeable battery. The power storage device 6 can have any number of cells and may be made of any material as will be appreciated by a person having ordinary skill in the art. Non-limiting example battery compositions that may be used as the power storage device 6, include nickel-cadmium, lead-acid, nickel-metal hydride, nickel zinc, silver zinc, lithium iron phosphate, lithium sulfur, sodium-ion, thin film lithium, zinc-bromide, zinc-cerium, vanadium redox, sodium-sulfur, molten salt, silver-zinc, quantum battery (oxide semiconductor) and lithium ion. The power storage device 6 can be capable of receiving and storing electrical power and providing electrical power to one or more components.

The power storage device 6 can comprise a series or arrangement of power storage devices 6, such as batteries arranged or electrically connected in series or parallel or other arrangement as may be preferable for the system 100. A power inverter (or inverter) 9, as shown in FIG. 3, can be electrically connected to the power storage device 6. The power storage device 6 may provide direct electrical current that can be converted to alternating electrical current at the inverter 9. The inverter 9 may have an electrical connection or output (not shown) that is connectable to external, electrical device or devices (not shown). The input voltage, output voltage and frequency, and overall power handling depend on the specifications of the power storage device 6 and/or the requirements necessary from the external, electrical device(s).

The power storage device 6 can be electrically connected to a controller 12 to manage and control electrical power to the inverter 9 and to and from the power storage device 6. The controller 12 can be electrically connected between the inverter 9 and the power storage device 6. The controller 12 can monitor an amount of power in the power storage device 6, such as by monitoring the current or voltage being provided to and/or from the power storage device 6 or other mechanism for determining the electrical power stored in the power storage device 6. The controller 12 can also monitor the amount of power required at the inverter 9, such as the amount of power required for any external devices connected to the inverter 9.

In an embodiment, the controller 12 can be configured to maintain a predetermined amount of power or charge to be stored in the power storage device 6. The controller 12 can compare the amount of power in the power storage device 6 to the predetermined amount of power. The predetermined amount of power or charge may be selected to maximize the amount of power stored on or in the power storage device 6 and maximize the life of the power storage device 6 and/or to prevent overcharging the power storage device 6. In an embodiment, the predetermined amount of power or charge may be as a non-limiting example between 80-99%, and may be between 85-95%, such as 90%, of the maximum amount of power or charge capable of being stored in the power storage device 6. If the power in the power storage device 6 is at the predetermined amount of power, the controller 12 may not send any further electrical power to the power storage device 6. If the power storage device 6 falls below the predetermined amount of power, the controller 12 can provide further electrical power to the power storage device 6.

As will be further described, a power source 102, generally shown in FIG. 1C and FIG. 3, can be electrically connected to the controller 12. The controller 12 can monitor the amount of power provided by the power source 102. The controller 12 can have logic and be configured to provide power from the power source 102 to the power storage device 6 if the power storage device 6 has less power or charge than the predetermined amount of power or charge. The controller 12 can cease providing power or divert power from the power source 102 to the power storage device 6 if the power or charge is at the predetermined amount of power or charge.

If the power required at the inverter 9 is less than the power provided by the power source 102, then the controller 12 can have logic and be configured to provide excess power from the power source 102 to the power storage device 6 until the power storage device 6 has the predetermined amount of power. If, on the other hand, the power required at the inverter 9 is more than the power being provided by the power source 102, then the controller 12 can have logic and be configured to provide power from the power storage device 6 and the power source 102 to the inverter 9 as required by the external devices connected to the inverter 9.

Furthermore, as will be further described, the controller 12 can adjust the amount of power provided from the power source 102 to the controller 12 in order to maintain the predetermined amount of power in the power storage device 6 and provide the power required to the inverter 9. The controller 12 can have logic and be configured to turn off the power source 102 if no power is required at the inverter 9 and the power storage device 6 is at the predetermined amount of power. In the event the power source 102 is off, the controller 12 can have logic and be configured to turn on the power source 102 if the power storage device 6 has less than the predetermined amount of power. If the power required at the inverter 9 is greater than the amount of power provided by the power source 102, then the controller 12 can have logic and be configured to increase the power generated from the power source 102. On the other hand, if the power required at the inverter 9 is less than the amount of power provided by the power source 102 and the power storage device 6 is at the predetermined amount of power, then the controller 12, as will be further described, reduce the amount of power provided by the power source 102 and/or direct power to be dissipated from the system 100.

FIG. 3 illustrates a regulator 14, such as a voltage regulator, electrically connected to the controller 12 can adjust an amount of power provided by the power source 102. The regulator 14 may dissipate power by generating heat, for example. In the embodiment shown, the power source 102 is comprised of a generator 3, fans 5, a turbine 1 (as shown in FIGS. 1C and 1D), bearings 2, and gears 4. In this example, the fans 5 provide wind energy to the system 100. The fans 5 can be sized and shaped to drive rotation of the turbine 1. In the embodiment shown in the figures, the fans 5 are arranged in a generally square-like configuration. The fans 5 are generally together similar in size to the size of the turbine 1. The fans 5 can be multiple fans, as shown in FIG. 3, such as two, three, four or even more fans as may be required by the system. As can be appreciated, the fans 5 can comprise any number of fans from one to hundreds or more depending on the application needed to efficiently provide wind energy to the system 100. The turbine 1 is shown in FIGS. 1C and 1D as a single turbine, but a person having ordinary skill in the art will appreciate that numerous turbines may be used and positioned to receive the wind energy from the fans 5.

The turbine 1 can be connected to gears 4 to generate power from the generator 3 through a set of bearings 2. The gears 4 can be helical gears 4 or other gears to efficiently impart rotational energy from the turbine 1 to the generator 3. As one example, the ratio of size of the turbine 1 to a size of the gears 4 may have a ratio that is larger than one, two, or even a magnitude greater, such as a ten to one ratio, to efficiently drive rotation of the generator 3. The size of the ratio may be modified depending upon the use of the system 100 as will be appreciated by a person having ordinary skill in the art. The power source 102 as shown in FIG. 1C as the turbine 1, gears 4, generator 3, and fans 5 can be replaced by other power generation systems, such as solar generating systems or other systems or arrangements capable of generating electrical power.

Turning to FIG. 3 again, as mentioned, the regulator 14 can dissipate power that is generated from the power source 102 that is in excess of the amount required by the inverter 9 and the power storage device 6. The regulator 14 can control the speed of the fans 5. In an embodiment, the controller 12 can be electrically connected to automatically adjust the regulator 14. The controller 12 is connected to the regulator 14 to automatically adjust the regulator 14 based on the power in the power storage device 6 and the power required at the inverter 9. Users of the system 100 can control the regulator 14 in addition to or instead of the controller 12.

By adjusting the speed of the fans 5, the amount of wind energy provided to the system 100 can be adjusted. Increasing the wind energy provided to the system 100, increases the power that is generated by the power source 102 (e.g. the turbine 1, gears 4, generator 3, and the fans 5) and is provided to the controller 12. Similarly, decreasing the wind energy provided to the system 100, reduces the power generated by the power source 102 and provided to the controller 12. If the power required at the inverter 9 is less than the power generated by the power source 102 and the power storage device 6 is at the predetermined amount, the regulator 14 can be adjusted to decrease the speed of the fans 5 to reduce the amount of energy that will be produced by the power source 102. If reducing the speed of the fans 5 still results in power from the power source 102 exceeding that required by the inverter 9 and the power storage device 6, the controller 12 can have logic and be configured to transmit power to the regulator 14 to dissipate power by the generation of heat or by other means. In other instances, the controller 12 can have logic and be configured to may be required to turn off the fans 5 and draw the power from the power storage device 6 below the predetermined amount and then turn the fans 5 on again. The controller 12 may have logic and be configured to turn the fans 5 on or off depending upon the power requirements.

Fuses 10 can be provided within the system 100 as may be required. For example, a fuse 10 can be provided between the generator 3 and a rectifier 11. The generator 3 may provide alternating electrical current that can be converted into direct current by allowing current to flow through the rectifier 11 in one direction only. One of the fuses 10 can be positioned between the controller 12 and the regulator 14. The fuses 10 can be used to prevent damage to the components of the system 100 that could be caused by irregular and damaging spikes in current. The fuses 10 can be sized depending on the components of the system 100. As a mere non-limiting example, if the power storage device is 24 Volts, the fuses 10 may be 200 amps, for example.

In an embodiment as shown in FIGS. 1A and 1B, the components of the system 100 as described above and as shown in FIGS. 1C and 1D (along with the components described in FIG. 3) can be contained in a single housing 17. FIGS. 1A and 1B shown an external view of the housing 17 having a general rectangular shape with curved sides. The housing 17 may have a removable portion, such as a lid 7, to reveal the components of the system 100 as shown in FIGS. 1C and 1D. The lid 7 may secure to a base 18 of the housing 17 by fastening mechanisms or connection mechanisms that are known in the art and will be appreciated by those having ordinary skill in the art.

An opening 19 is provided in the housing 17 to permit air to flow into the housing 17 and/or for heat to dissipate from the housing 17. The opening may have a mesh or other substance that prevents water or liquid from protruding into the housing 17 while permitting air/wind to enter the housing 17. The housing 17 can be made of any substance. In an embodiment, the housing 17 is made of a durable and lightweight substance, such as nylon. Within the housing 17, such as secured to the lid 7, is a sound dampening material. Examples of the sound dampening material include but should not be limited to foam panels, such as acoustic foam panels, tire rubber materials, such as recycled tire rubber sound reducing materials, acoustic panels, or other materials or devices that can be appreciated by those having ordinary skill in the art.

An autonomous self-charging system 100 has been described herein. The system 100 can generate power and store power to provide constant power to external devices. The system 100 is scalable depending upon the application and the external devices, whether a power plant, air conditioner, cell phone, residential home, outdoor lights or other electrical devices. The system 100 may be self-contained in a single housing 17. The system 100 can utilize a power source 102, such as the turbine 1, the gears 4, the generator 3, and the fans 5, to provide power to the system 100. In the example of the fans 5, the turbine 1, the gears 4 and the generator 3 work together to convert the wind energy into electrical energy. As described, other power sources may be used within the spirit of the invention. The power storage device 6 is electrically connected to the controller 12 to provide power to the fans 5 and the inverter 9. The regulator 14 is electrically connected to the fans 5 to adjust the speed of the fans 5 and thus adjust the amount of power that is generated from the generator 3. The controller 12 is configured to maintain a predetermined charge in the power storage device 6 and provide the power required by the inverter 9. The controller 14 can turn off the fans 5 if the power storage device 6 is at the predetermined charge and no power is required at the inverter 9. The controller 12 can direct excess power to be dissipated at the regulator 14.

What is claimed is:

1. A system comprising
a rechargeable power storage device capable of storing power and providing electrical power;
an inverter electrically connected to the rechargeable power storage device and connectable to an external device, the inverter configured to provide power to the external device; and
a controller configured to manage and control electrical power to the inverter and the rechargeable power storage device, the controller monitoring an amount of power in the rechargeable power storage device and monitoring the power required at the inverter, wherein the controller is configured to maintain a predetermined amount of power in the rechargeable power device and provide the power required to the inverter.

2. The system of claim 1 further comprising:
a power source providing power the controller.

3. The system of claim 2 further comprising:
a regulator capable of adjusting an amount of power provided by the power source.

4. The system of claim 3 wherein the controller determines an amount of power in the rechargeable power storage device and compares the amount of power to the predetermined amount of power.

5. The system of claim 4 wherein the controller detects an amount of power provided by the power source and an amount of power required at the inverter.

6. The system of claim 5 wherein the controller is configured to provide power to the rechargeable power storage device if the power required at the inverter is less than the power provided by the generator.

7. The system of claim 5 wherein the controller is configured to provide power to the rechargeable power storage device if the power required at the inverter is more than the power provided by the generator.

8. The system of claim 5 wherein the controller is configured to turn off the power source if no power is required at the inverter and the rechargeable power storage device is at the predetermined amount of power.

9. The system of claim 5 wherein the controller is configured to adjust the power source to provide the power required by the inverter and to provide the power required to maintain the rechargeable power storage device at the predetermined amount of power.

10. The system of claim 9 further comprising:
a voltage regulator electrically connected to the controller to adjust an amount of power provided by the power source.

11. The system of claim 10 wherein the controller is connected to the voltage regulator to automatically adjust the voltage regulator based on the power in the rechargeable power storage device and the power required at the inverter.

12. The system of claim 5 wherein the controller automatically turns on the power source if the rechargeable storage device is below the predetermined amount or power is required at the inverter.

13. The system of claim 5 wherein the power source comprises one or more fans, a turbine and a generator electrically connected, and further wherein the system is contained within a single housing.

14. A system comprising
a fan rotatable to provide wind energy into the system;
a turbine and generator capable of converting the wind energy into electrical energy;
a rechargeable battery providing electrical power to the fan;
a regulator electrically connected between the fan and the rechargeable battery to adjust an amount of power provided to the fan;
an inverter electrically connected to the rechargeable battery and the generator for providing electrical power to devices external to the system; and
a controller electrically connected to control the power to and from the rechargeable battery, to the regulator, and to the inverter, wherein the controller is configured to maintain a predetermined charge in the rechargeable battery and provide the power required by the inverter.

15. The system of claim 14 wherein the controller is configured to turns off the fan if the rechargeable battery is at the predetermined charge and no power is required at the inverter.

16. The system of claim 15 further comprising:
a single housing having a sound dampening material provided therein and securing the fans, the turbine and generator, the regulator, the controller and the inverter.

17. The system of claim 14 wherein the controller is configured to provide power to the rechargeable battery if the rechargeable battery is below the predetermined amount.

18. A method comprising:
providing a single, self-contained housing having a battery and an electrical connection for powering an electrical, external device;
drawing air or wind into the housing with a plurality of fans positioned within the housing;
converting the air or wind energy into electrical energy within the housing;
providing electrical power to the electrical connection and the battery;
controlling the power to maintain a predetermine amount of energy in the battery and for providing the power required at the electrical connection by the external device.

19. The method of claim 18 further comprising:
monitoring the power provided by the generator, the amount of power in the battery and the amount of power required by the external device, and further comprising directing power to the battery if the battery is below the predetermined amount of energy.

20. The method of claim 19 further comprising:
controlling the fan to generate the power required to maintain the battery at the predetermined amount of energy and to provide the power required at the electrical connection.
